(19) United States
(12) Patent Application Publication
(10) Pub. No.: US 2017/0269003 A1
(43) Pub. Date: Sep. 21, 2017

(54) EXTERIOR INSPECTION DEVICE

(71) Applicant: PUREX Co., Ltd., Kagawa (JP)

(72) Inventors: Yasuhiko ENAMI, Kagawa (JP); Yo-o HAYASHIDA, Kagawa (JP)

(21) Appl. No.: 15/505,235

(22) PCT Filed: Aug. 10, 2015
(86) PCT No.: PCT/JP2015/004005

§ 371 Date: Feb. 20, 2017

(30) Foreign Application Priority Data
Oct. 23, 2014 (JP) 2014-216015

(51) Int. Cl. G01N 21/88; H04N 5/225; H04N 9/07; H04N 9/73

(52) U.S. Cl. CPC G01N 21/8806; H04N 9/735; H04N 5/2256; H04N 9/07; G01N 2021/8835

(57) ABSTRACT

Provided is an exterior inspection device capable of performing inspections with an optimum white balance at all times. This exterior inspection device A is equipped with a camera 1, an inspection reference plane 2, and a light source 3, the exterior inspection device further comprising: a calibration reference plate 4; an advance/retraction mechanism 5 for advancing and retracting the calibration reference plate 4 between a calibration position within an image-taking area of the camera 1 and a retracted position retracted therefrom; and a control unit for issuing a white balance adjustment command to the camera 1 when the calibration reference plate 4 is at the calibration position. On an occasion of a non-inspection state in which no exterior inspection is being executed, the control unit 6 issues to the advance/retraction mechanism 5 a drive command for moving the calibration reference plate 4 to the calibration position, an adjustment command for adjusting light quantity of the light source 3, and a white balance adjustment command. Therefore, the white balance adjustment can be fulfilled automatically without involving human work.

### TECHNICAL FIELD

The present invention relates to an exterior inspection device. More specifically, the invention relates to an exterior inspection device including an automatic calibration function of a camera.

### BACKGROUND ART

Exterior inspection devices using a camera nowadays are used in every field. Typical examples thereof include finish lines of linen supply plants, production lines of semiconductor wafer, inspection lines of printed matter, production lines of printed circuit boards, and the like.

A camera to be used in an exterior inspection device captures an image in such fashion that the optical power spectrum of an actual sight is reproduced as it is. However, since the human vision views a subject with natural hues, images captured by such cameras may be unnatural in some cases.

When an image captured by a camera has no naturalness similar to that by the human eyes, even a subject that seems abnormal for the human eyes may be unrecognizable as abnormal by image information captured by the camera, making it impossible to achieve a correct exterior inspection. For this reason, the camera is subject to compensation to obtain a desired hue. This compensation is called white balance. It is noted that the term, white balance, is derived from the compensation typified by the way how pure white subjects are shot.

With various types of exterior inspection devices also, use of a camera involves white balance adjustment. The following related arts have been available for the white balance adjustment.

As to a related art of PTL 1, it is described that the white balance process is performed by personal computer. However, there is no disclosure as to how a subject serving as a reference of compensation (so-called calibration reference plate) is treated.

As to a related art of PTL 2, it is described that the white balance process is controlled on a basis of spectral characteristics of reflected light at a workpiece surface. However, there are no disclosures of concrete techniques as to which state of the workpiece is referenced, or how the workpiece is treated.

In this connection, whereas a color line camera with image sensors arrayed in line is used for exterior inspection devices, the white balance in such color line cameras is, in general, slightly varied by temperature drifts or secular changes.

In such cases, continuing to execute exterior inspections without awareness of loss of the white balance would make it impossible to achieve correct inspections, as a problem.

### CITATION LIST

### Patent Literature

PTL 1: JP 2009-115681 A

PTL 2: JP 2014-89156 A

### SUMMARY OF INVENTION

### Technical Problem

The present invention having been accomplished in view of the above-described circumstances, an object of the invention is to provide an exterior inspection device capable of executing inspections with an optimum white balance at all times.

### Solution to Problem

In a first aspect of the invention, there is provided an exterior inspection device equipped with a camera, an inspection reference plane, and a light source, the exterior inspection device further including: a calibration reference plate; an advance/retraction mechanism for advancing and retracting the calibration reference plate between a calibration position within an image-taking area of the camera and a retracted position retracted therefrom; and a control unit for issuing a white balance adjustment command to the camera when the calibration reference plate is at the calibration position.

In a second aspect of the invention, in the exterior inspection device as defined in the first aspect, the control unit issues to the advance/retraction mechanism a drive command for moving the calibration reference plate to the calibration position on an occasion of a non-inspection state in which no exterior inspection is being executed.

In a third aspect of the invention, in the exterior inspection device as defined in the first or second aspect, the control unit issues an adjustment command for adjusting light quantity of the light source when the calibration reference plate is at the calibration position.

### Advantageous Effects of Invention

According to the first aspect, when the advance/retraction mechanism has moved the calibration reference plate to the calibration position, the control unit issues a white balance adjustment command to the camera. Thus, the white balance adjustment can be fulfilled automatically without involving human work.

According to the second aspect, on an occasion of a non-inspection state, the control unit actuates the advance/retraction mechanism to move the calibration reference plate to the calibration position. Thus, the white balance adjustment can be fulfilled without involving human work.

According to the third aspect, on an occasion of the white balance adjustment, the control unit issues a command for adjusting the light quantity of the light source. Thus, the white balance adjustment can be fulfilled correctly.

### BRIEF DESCRIPTION OF DRAWINGS

FIG. 1 is a basic configuration explanatory view of an exterior inspection device according to the present invention;

FIG. 2 is an explanatory view of an exterior inspection device according to an embodiment of the invention; and

FIG. 3 is an enlarged view of a main part of FIG. 2.

### DESCRIPTION OF EMBODIMENTS

Hereinbelow, an embodiment of the present invention will be described with reference to the accompanying drawings.

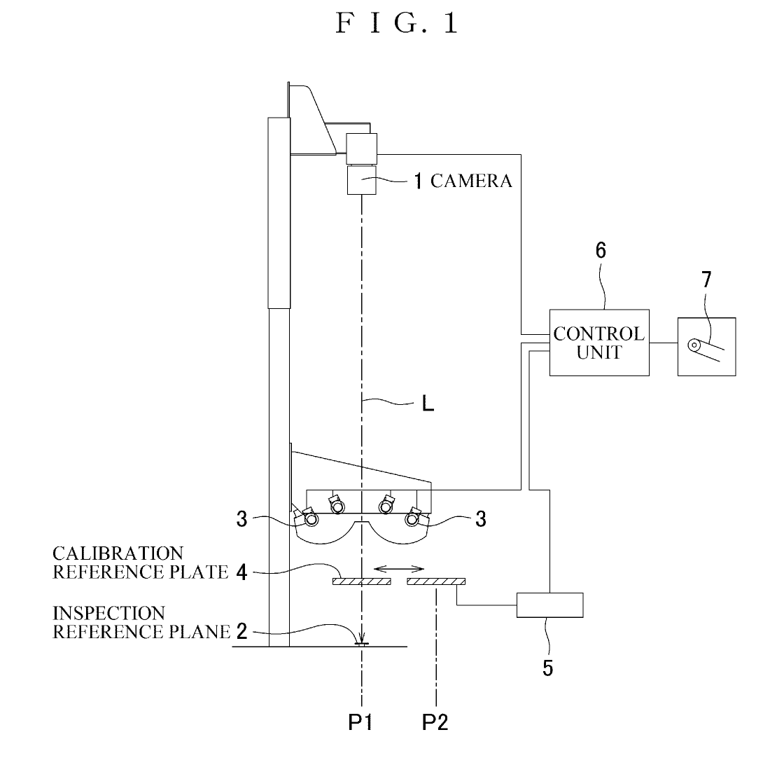

A basic configuration of the present invention will be described with reference to FIG. 1.

The exterior inspection device of the invention includes a camera 1, an inspection reference plane 2 placed at an image pickup position of the camera 1, and light sources 3 for applying light to the inspection reference plane 2. A line L between the camera 1 and the inspection reference plane 2 is a surface inspection line. These component members are those included in ordinary exterior inspections devices.

The camera 1 has a built-in white balance adjustment function.

The light sources 3 are LEDs, fluorescent lamps or the like plus a control board therefor. The control board has a built-in function for switching over between normal inspection-use light quantity and white balance-use light quantity.

The invention includes the following members in addition to the above-described ones.

Reference sign 4 denotes a calibration reference plate, and 5 denotes an advance/retraction mechanism therefor. Reference sign 6 denotes a control unit which has a control function for automatically performing white balance adjustment.

The calibration reference plate 4 is a subject serving as a reference for white balance adjustment. Therefore, a white flat plate as an example is used therefor.

The advance/retraction mechanism 5 is a driving device for advancing and retracting the calibration reference plate 4 between a calibration position P1 and a retracted position P2 retracted therefrom. Although any driving device, only if capable of advancing and retracting the calibration reference plate 4, may be used therefor, yet an air cylinder, various types of electric actuators, and the like are preferable from the viewpoint of driving the lightweight calibration reference plate 4.

The control unit 6 is implemented by an information processing device such as a computer. Then, the control unit 6 has the following control functions:
1) issuing a white balance adjustment command to the camera 1,
where since the camera 1 has a built-in white balance adjustment function, issuing the adjustment command allows white balance adjustment to be autonomously performed;
2) issuing motion commands for advancing motion and retracting motion of the advance/retraction mechanism 5; and
3) performing light quantity adjustment for the light sources 3,
where since the light sources 3 have a built-in light quantity adjustment function, issuing an adjustment command allows the light quantity to be autonomously adjusted to one suitable for white balance adjustment.

A discriminative signal for discriminating between driven state and non-driven state is inputted to the control unit 6 from a conveyor 7 which feeds inspection objects to be inspected. During the execution of a normal workpiece inspection, i.e. exterior inspection, the conveyor 7 is being driven. On the other hand, during a non-inspection time, the conveyor 7 is not being driven, so that the discriminative signal indicative of the non-driven state is inputted to the control unit 6. The discriminative signal may be implemented by using any arbitrary means such as a switch which turns on upon a halt of the conveyor 7 or a tachometer which involves rotation and non-rotation of a roller.

According to the invention, during the non-driven state of the conveyor 7, the control unit 6 starts various operations involved in white balance adjustment.

More specifically, a state that the conveyor 7 is halted develops at an everyday operation start, or during a time interval occurring after inspection of seriate inspected articles and before arrival of a next inspection article, or other occasions.

During this non-inspection time, three command signals are automatically issued from the control unit 6.

First, the advance/retraction mechanism 5 operates so that the calibration reference plate 4 positioned at the retracted position P2 is advanced to the calibration position P1. With the calibration set ready in this way, light quantity adjustment for the light sources 3 is commanded while a white balance adjustment command is issued to the camera 1. As a result of this, the camera 1 adjusts the white balance on a basis of its built-in functions under proper light quantity.

Upon an end of the white balance adjustment, the control unit 6 issues a retraction signal to the advance/retraction mechanism 5 to make the calibration reference plate 4 retracted. Then, the light quantity of the light sources 3 is restored to a normal inspection-use light quantity, where the white balance adjustment of the camera 1 is ended.

Through the above-described process, according to the invention, the white balance adjustment can be achieved automatically without involving human work.

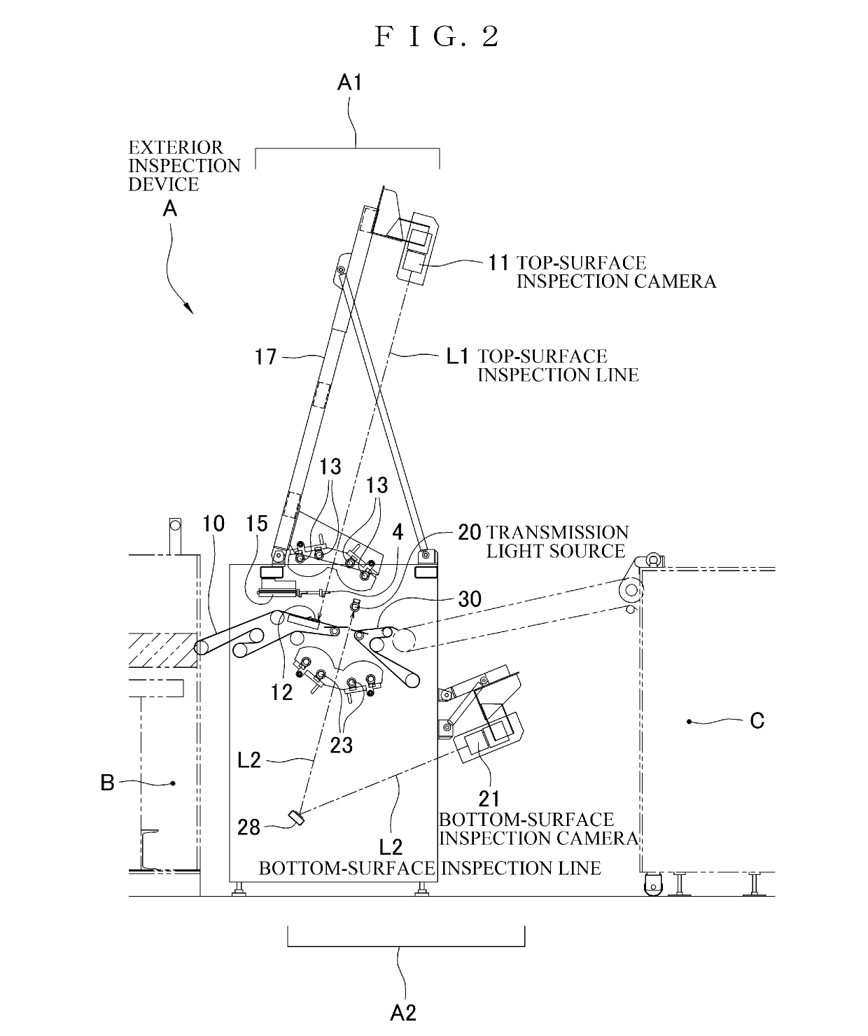

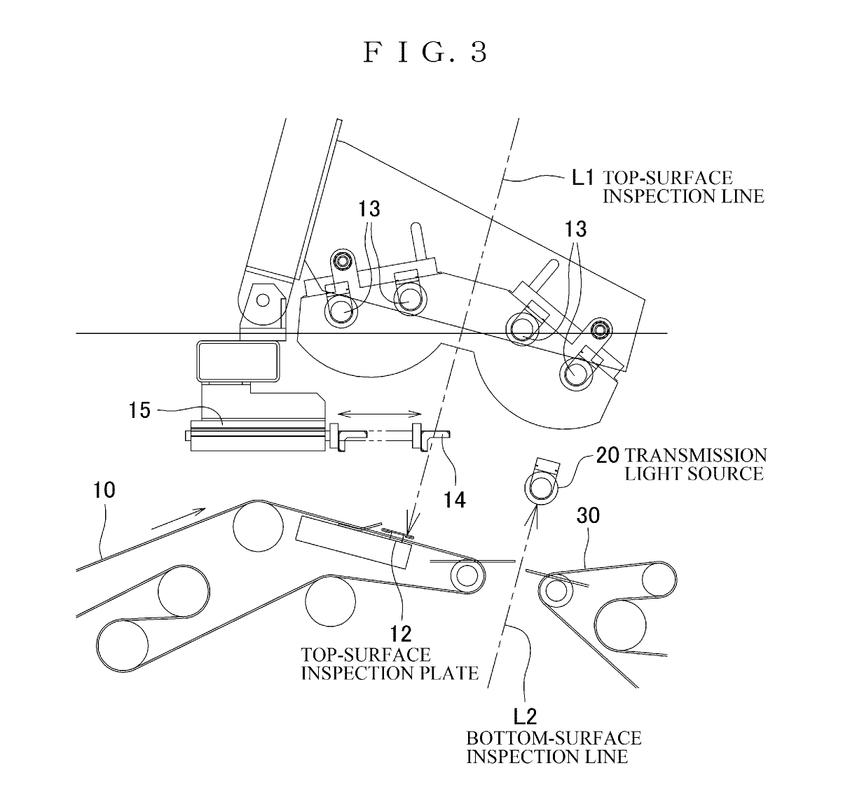

Next, an embodiment of the invention will be described with reference to FIGS. 2 and 3.

Provided by the embodiment is an exterior inspection device A in a fabric-article finish line of a linen supply plant, the exterior inspection device A being installed between a preceding-step device B (e.g., ironing device) and a succeeding-step device C (e.g., folding device). The exterior inspection device A includes a top-surface inspection device A1 for inspecting a top surface of an inspection object, and a bottom-surface inspection device A2 for inspecting its bottom surface.

The exterior inspection device A is provided, in its main body, with an inlet-side conveyor 10 for feeding in inspection-object fabric articles such as sheets, wrapping cloths and pillow cases from the preceding-step device B as well as with an outlet-side conveyor 30 for feeding those articles out to the succeeding-step device C.

First, the top-surface inspection device A1 will be described.

A top-surface inspection plate 12 is placed on an upper surface of the inlet-side conveyor 10. When an inspection-object fabric article passes on the upper surface of the top-surface inspection plate 12, an exterior inspection for the fabric article is executed. Therefore, the upper surface of the top-surface inspection plate 12 corresponds to the inspection reference plane 2 as defined in the appended claims.

A top-surface inspection camera 11 is installed above the top-surface inspection plate 12. The top-surface inspection camera 11 is attached to a distal end of a pillar 17 in such a way that its lens is directed downward. A top-surface inspection line L1 passes between the lens of the top-surface inspection camera 11 and the top-surface inspection plate 12. Also, light sources 13 are attached in lower part of the pillar 17. The light sources 13 illuminate a surface of the top-surface inspection plate 12 with light.

An advance/retraction mechanism 15 is placed at a root of the pillar 17 via a bracket. The advance/retraction mechanism 15 is implemented by an air cylinder, with a calibration reference plate 14 mounted on its piston rod. As the calibration reference plate 14 is advanced, the calibration reference plate 14 is brought to a position passing through the top-surface inspection line L1. This position is the calibration position. When the air cylinder is contracted to make the calibration reference plate 14 retracted, the calibration reference plate 14 comes to the retracted position.

A bottom-surface inspection device A2 is placed on an outlet side of the top-surface inspection device A1.

A transmission light source 20 is placed at a slightly upper portion within a space between the inlet-side conveyor 10 and the outlet-side conveyor 30, and light sources 23 are placed in slightly lower part of that space. A bottom-surface inspection camera 21 is mounted on a side wall of the main body of the exterior inspection device. An optical path between the bottom-surface inspection camera 21 and the transmission-use light sources 23 is connected up via a reflecting mirror 28. This optical path serves as a top-surface inspection line L2.

In FIG. 2, although neither a calibration reference plate nor an advance/retraction mechanism is provided for the bottom-surface inspection line L2, yet those members may be provided also for the bottom-surface inspection device A2 as in the top-surface inspection device A1.

According to the exterior inspection device A1 of the above-described first embodiment, when the control unit 6 comes to a non-inspection state, the advance/retraction mechanism 5 is actuated so that the calibration reference plate 4 is brought to the calibration position. Therefore, the white balance adjustment can be achieved without involving human work. Since the control unit 6 issues a command for adjusting the light quantity of the light sources 3 on an occasion of the white balance adjustment, a correct white balance adjustment can be fulfilled. When the advance/retraction mechanism 5 has moved the calibration reference plate 4 to the calibration position, the control unit 6 issues a white balance adjustment command to the camera 1. Therefore, the white balance adjustment can be fulfilled automatically without involving human work.

### Other Embodiments

The foregoing embodiment has been applied to a sheet finish line of a linen supply plant. Otherwise, the invention is applicable also to exterior inspection devices in various technical fields such as production lines of semiconductor wafer, inspection lines of printed matter, and production lines of printed circuit boards.

### REFERENCE SIGNS LIST

A exterior inspection device

A1 top-surface inspection device

A2 bottom-surface inspection device

1 camera

2 inspection reference plane

3 light source

4 calibration reference plate

5 advance/retraction mechanism

6 control unit

7 conveyor

10 inlet-side conveyor

11 top-surface inspection camera

12 top-surface inspection plate

13 light source

14 calibration reference plate

15 advance/retraction mechanism

20 transmission light source

21 bottom-surface inspection camera

23 light source

30 outlet-side conveyor

1. An exterior inspection device equipped with a camera, an inspection reference plane, and a light source, the exterior inspection device further comprising:
a calibration reference plate;
an advance/retraction mechanism for advancing and retracting the calibration reference plate between a calibration position within an image-taking area of the camera and a retracted position retracted therefrom; and
a control unit for issuing a white balance adjustment command to the camera when the calibration reference plate is at the calibration position.

2. The exterior inspection device in accordance with claim 1, wherein
the control unit issues to the advance/retraction mechanism a drive command for moving the calibration reference plate to the calibration position on an occasion of a non-inspection state in which no exterior inspection is being executed.

3. The exterior inspection device in accordance with claim 1, wherein
the control unit issues an adjustment command for adjusting light quantity of the light source when the calibration reference plate is at the calibration position.
